(19) United States
(12) Patent Application Publication
(10) Pub. No.: US 2008/0035357 A1
(43) Pub. Date: Feb. 14, 2008

(54) HITCH LIFT ARM CONNECTION

(76) Inventor: Martin Heitlinger, Ostingen-Odenheim (DE)

Correspondence Address: DEERE & COMPANY, ONE JOHN DEERE PLACE, MOLINE, IL, 61265, US

(21) Appl. No.: 11/836,294

(22) Filed: Aug. 9, 2007

(30) Foreign Application Priority Data
Aug. 10, 2006 (DE) 10/2006 037527.0

(51) Int. Cl. A01B 59/06

(52) U.S. Cl. 172/439

(57) ABSTRACT

The invention relates to a connection between the lift arm and lift shaft of an implement hitch. There is a need for such a connection which is less subject to wear. The lift arm has an end with a opening which receives an end of the lift shaft. The ends of the lift shaft and the openings of the lift arm are of substantially complementary design to one another. The openings of the lift arms and the ends of the lift shaft have a polygonal cross sectional shape, thus forming a polygonal connection.

### FIELD OF THE INVENTION

The present invention relates to a connection between a lift arm and a lift shaft of an implement hitch.

### BACKGROUND OF THE INVENTION

Agricultural or industrial utility vehicles are often provided with a three-point hitch for mounting or coupling to a working implement. In the case of an agricultural utility vehicles, such as a tractor, ploughs, seeding machines, cultivators and similar mounted implements are coupled to the tractor by means of the three-point hitch. In the case of industrial utility vehicles, mowing mechanisms or snow removal blades, for example, are coupled to the utility vehicle by means of the three-point hitch.

A three-point hitch is described the DIN Standard ISO 730-1. Such a three-point hitch has an upper link, two lower links and a lifting mechanism. The lifting mechanism usually includes a pair of lift cylinders, a lift shaft and two lift arms. The lift shaft is rotatably mounted in bearings which are fixed to the utility vehicle. An end of each lift arm is non-rotatably fixed to an end of the lift shaft. The lift arm is pivotally coupled to the lift cylinder. The other end of each lift arm is pivotally coupled to an end of a lift strut. The other end of the lift strut is coupled to the lower link. If the lifting cylinders are extended, a force is exerted on the lift arm, so that the lift arms are rotated together with the lift shaft so that, that end of the lift arms are pivoted upwards. If different forces are applied to the left and right lift arms, then a torque will be applied to the lift shaft.

The components of a three-point hitch are subject to high forces and to a high degree of wear. Accordingly, three-point hitch components are formed from hardened steel, especially in the regions where the lift shaft and the lift arms are coupled to each other. The lift shaft and the lift arms are conventionally coupled together by a toothed or splined shaft connection.

Considerable percussive forces act on an operating three-point hitch. These forces can cause wear on the splined connection between the lift shaft and the lift arms, so that under some circumstances, after an extended period of time, the lift shaft and/or the lift arms must be replaced. Wear is caused by relative movement or “play”, over the course of time, between the lift arm and the lift shaft. Such play increases during the course of further operation.

### SUMMARY OF THE INVENTION

Accordingly, an object of this invention is to provide a lift arm to a lift shaft connection which overcomes or reduces wear problems.

A further object of the invention is to provide such a connection which has substantially comparable properties to the conventional connection.

These and other objects are achieved by the present invention, wherein the invention relates to a connection of a lift arm to a lift shaft of a three-point hitch for an agricultural or industrial utility vehicle. The lift arm has a mounting region with a shaft opening or recess for receiving an end of the lift shaft. The lift shaft has ends or mounting regions which engage the lift arms. The opening of the lift arm receives and engages around the lift shaft at the mounting region of the lift shaft. The opening of the lift arm could engage completely or almost completely around the lift shaft at the mounting region of the lift shaft. The lift shaft and the lift arms have substantially complementary shaped mounting regions. The lift arms are non-rotatably connected to the lift shaft. The lift shaft and the lift arms have mounting regions which have a polygonal cross sectional shape—thus forming a polygonal connection.

It is recognized that a splined shaft connection is entirely suitable for transmitting percussive torques and is therefore also utilized for a connection between the lift shaft and lift arm. However, wear can occur which could be caused in particular by notching actions of the individual teeth of the splined shaft connection. The asymmetrical loading of the lower members and of the lift arms when asymmetrically designed working implements are coupled thereon, can also have an adverse effect on the conventional mounting regions between the lift arm and lift shaft. Therefore, a polygonal connection between the lift arms and lift shaft is proposed. Such a polygonal connection is better than other form-fitting connections with respect to notching action. Such a polygonal connection is also self-centering, as a result of which any play which may be present is compensated for during a rotation. Furthermore, the production of the components for a polygonal connection is simpler, cheaper and more precise than a splined connection. The production requires a corresponding special machine. A polygonal connection is particularly suitable for transmitting percussive torques.

Any desired polygon between which substantially planar connecting regions extend could be used as a polygonal cross section. Preferably, however, the polygonal connection has a cross-sectional shape which corresponds substantially to an equilateral triangle with rounded sides and/or corners. The cross-sectional shape could be that of an orbiform curve.

Preferrably, the polygonal connection has a cross-sectional shape which corresponds substantially to an equilateral polygon, in particular a square or a hexagon. The sides and/or the corners of the polygon could be of rounded design. Such a design relates both to the shape of the lift arm and the shape of the lift shaft. With the lift shaft and the lift arm in surface contact with each other, forces are efficiently transmitted therebetween. The rounded corners could have a circular or elliptical cross-sectional region.

The polygonal connection between the lift shaft and the lift arm is fundamentally preferably designed such that there is surface contact between the mounting regions of the lift shaft and of the lift arm. Such surface contact is preferably sought over the entire periphery of the opening of the lift arm. Accordingly, the cross sections of the mounting regions of the lift shaft and of the lift arm are of corresponding design, with regard also to the tolerances.

Preferably, the lift arm has a rounded or planar side region of the polygonal cross-sectional shape which is substantially parallel to the upper or lower outer surface of the lift arm. Accordingly, the outer region of the lift arm has an approximately uniform thickness in cross section, so that the material of the lift arm in said region is uniformly loaded. There is therefore almost no material fatigue or material loading at this region.

Preferably, the lift arm has a slot which extends radially outwardly from the shaft opening. Alternatively, the slot could extend in a direction which is aligned between the radial direction and a direction which is perpendicular thereto. The slot could be formed after the shaping production of the lift arm, for example by means of sawing. In this way, the inner diameter of the opening can be enlarged slightly. This is advantageous when mounting the lift arm onto the lift shaft since, on account of the slightly enlarged inner diameter of the opening, the lift arm can, with sufficient play, be pushed onto the lift shaft with little force expenditure.

Preferably, the lift arm is clamped to the lift shaft by a screw or bolt and a nut. The screw could hereby be insertable into two bores which are aligned with one another and arranged substantially perpendicular to the profile of the slot.

The slot is preferably positioned and formed so that the lift arm can be easily pushed onto the lift shaft. The slot is formed in a central end region of the lift arm in a plane which is aligned parallel to the longitudinal direction of the lift arm and parallel to the longitudinal axis of the opening of the lift arm.

Preferably, the lift shaft has two mounting regions, one at each end, so that a lift arm can be mounted on each end of the lift shaft. The lift arm is secured in the longitudinal direction of the lift shaft by a screw or bolt which extends into an end bore and a securing plate which has an outer diameter which is greater than the inner diameter of the opening of the lift arm. A shoulder could be provided on the lift shaft from the inner side of the lift shaft, with which shoulder a lift arm comes into contact.

The lift shaft may be rotatably mounted in a bearing which is provided on the utility vehicle. Alternatively or in addition, the lift arm is pivotally coupled to a lifting strut, which is connected to a lower link of the three-point hitch. The lift arm may also be pivotally coupled to a lifting cylinder. Thus, the lift shaft/lift arm connection may be used on an otherwise conventional three-point hitch. A modular kit with a lift shaft and two lift arms with a polygonal connection therebetween could be used to upgrade a hitch with conventional splined shaft/arm connections.

The lift shaft and/or the lift arm may be case hardened to reduce wear to the polygonal connection.

### BRIEF DESCRIPTION OF THE DRAWINGS

FIG. 1 is a perspective view of a hitch embodying the invention;

FIG. 2 is side view of a hitch lift arm according to the present invention;

FIG. 3 is a perspective view of a hitch lift arm according to the present invention;

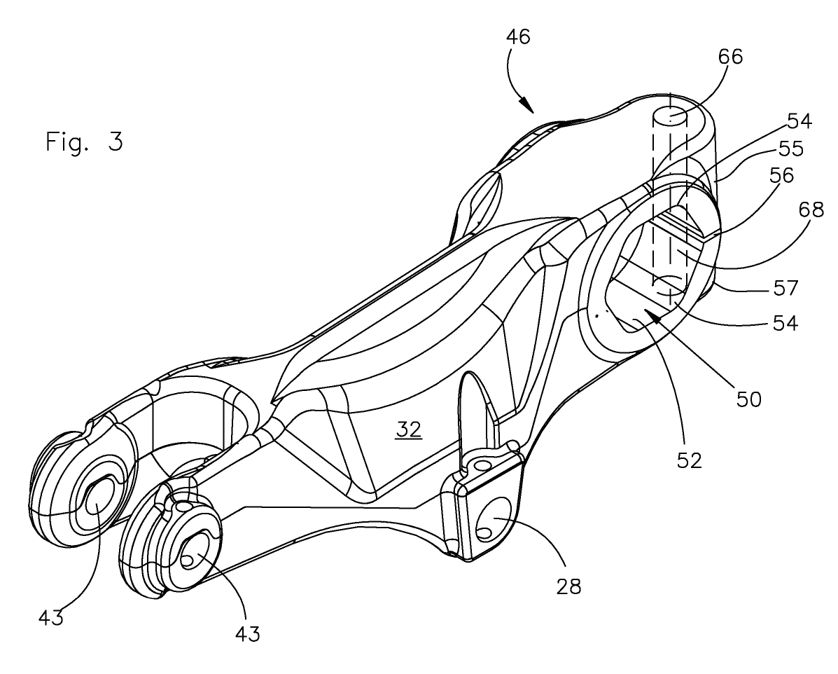

FIG. 4 is an end view of the hitch lift shaft of FIG. 1; and

FIG. 5 is a perspective view of the hitch lift arm of FIG. 1.

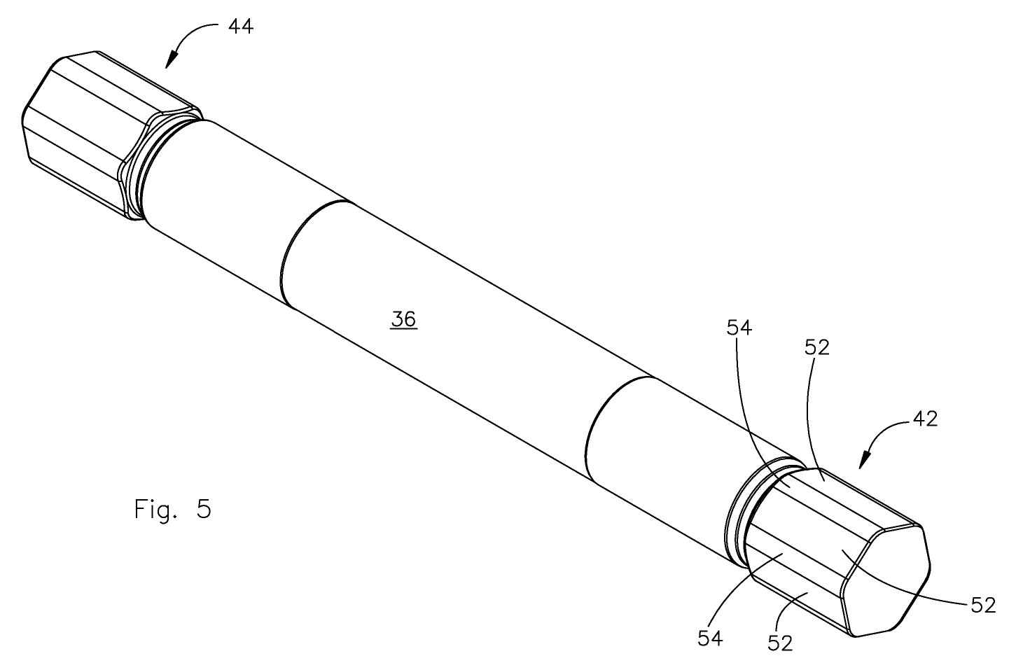

### DESCRIPTION OF THE PREFERRED EMBODIMENT

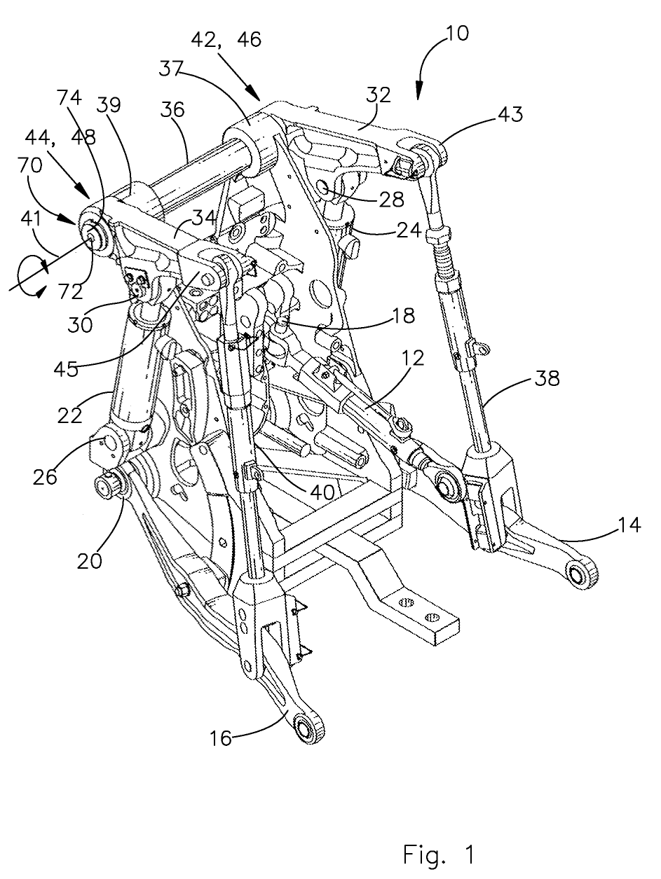

Referring to FIG. 1, a three-point hitch 10 may be mounted in the rear of a tractor (not shown). The three-point hitch 10 has an upper link 12 and two lower links 14, 16. The upper link 12 has a forward end pivotally mounted on the vehicle at the mounting point 18. The lower links 14,16 have forward ends pivotally mounted on the vehicle at the mounting point 20.

The three-point hitch 10 also includes two lift cylinders 22, 24. A lower end of each lift cylinder 22, 24 is pivotally supported at mounting point 26. The upper end of each lift cylinder 22, 24 is pivotally coupled to the a lift arm 32, 34 at articulation point 28, 30. The lift arms 32, 34 have forward ends fixed for rotation to a corresponding end to a lift shaft 36. The aft ends of the lift arms 32, 34 are pivotally coupled to the upper end of a corresponding lift struts 38, 40 at articulation points 43, 45. The lower end of each lift strut 38, 40 is pivotally coupled to a corresponding lower link 14, 16.

The lift shaft 36 is supported for rotation about axis 41 by bearings 37, 39, which are mounted on the utility vehicle (not shown). The lift arms 32, 34 are mounted on the ends or mounting regions 42, 44 of the lift shaft 36.

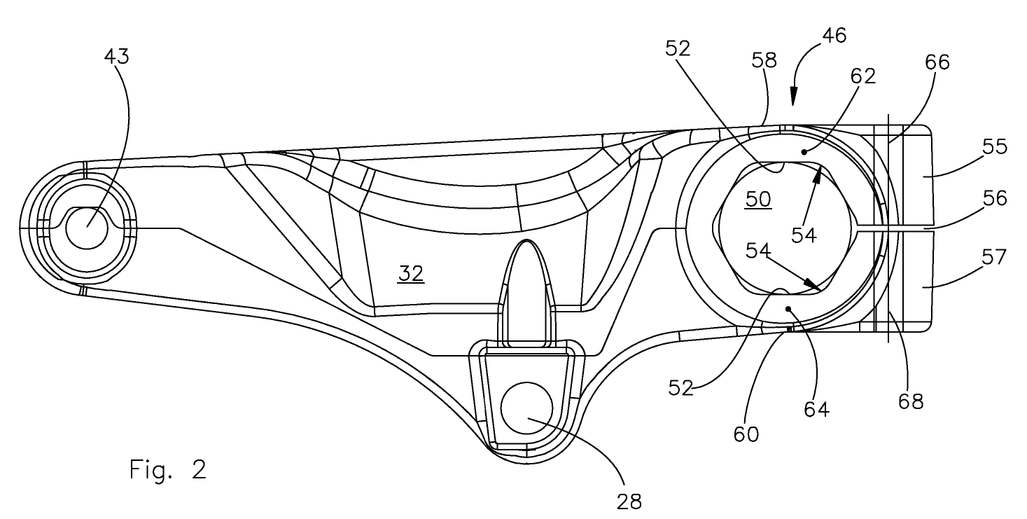

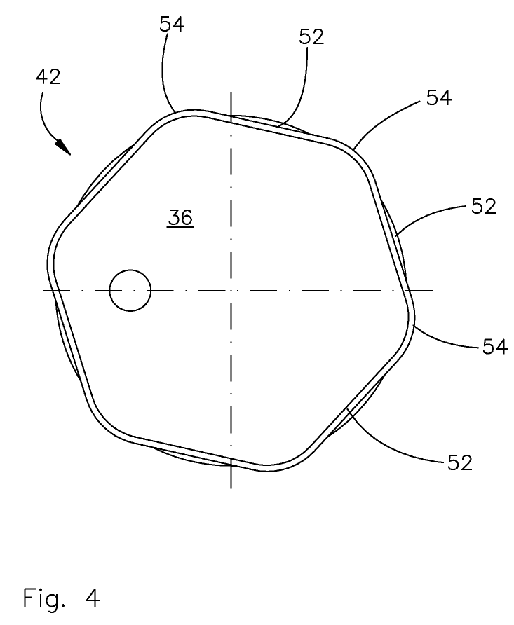

Each lift arm 32, 34 has a mounting region 46, 48 which forms a shaft opening 50 which receives an end of the lift shaft 36. The opening 50 receives and engages the ends 42, 44 of the lift shaft 36. The lift shaft ends 42, 44 and the openings 50 have substantially complementary shapes. Preferably, the ends 46, 48 and the openings 50 have a polygonal cross section, as best seen in FIGS. 2 and 4. Thus, there is a polygonal connection between the lift shaft 36 and the lift arm 32, 34.

Referring to FIG. 2, the opening 50 has an equilateral hexagonal shape, with substantially rectilinear surfaces 52 and rounded corners 54. The rounded corners 54 have a substantially circular cross-sectional region. Referring to FIG. 4, the end 42 of the lift shaft 36 is also designed as a polygon in the form of an equilateral hexagon with surfaces 52 and rounded corners 54. Accordingly, the mounting region 46 and the opening 50 have shapes which are complementary to shape of the shaft end 42.

There is surface contact between the mounting regions 42, 44 of the lift shaft 36 and the mounting regions 46, 48 of the lift arm 32, 34. The surface contact extends substantially over the entire periphery of the opening 50 of the lift arm 32, 34, with the exception of the slot 56.

The surfaces 52 are parallel to the outer surface 58, 60 of the lift arm 32, 34 so that there is a substantially uniform material thickness in the two regions 62, 64, which largely prevents material fatigue in that region. Region 62 is arranged between the upper, outer surface 58 and the surface 52. Region 64 is arranged between the lower, outer surface 60 and the surface 52.

Each lift arm 32, 34 includes a pair of end parts 55, 57 which are separated by a slot 56 which extends radially outwardly from opening 50. The slot 56 is formed after the lift arm 32 has been cast and the polygonal opening 50 has been formed. As a result, the separation of the end parts 55, 57 can be increased slightly, thereby making it easier for the lift arm 32 to be pushed onto the lift shaft 36. The lift arm 32, 34 can be clamped to the lift shaft 36 by a screw or bolt and nut (not shown) can be inserted through aligned bores 66, 68, which are aligned perpendicular to the slot 56.

As best seen in FIG. 1, a securing member 70 secures the lift arm 34 to the lift shaft 36 and prevents movement of the lift arms 32, 34 in the longitudinal direction. The lift shaft 36 has an end bore 72 into which a screw (not shown) can be screwed to attach a securing plate 74 to the end of the shaft 36. The securing plate 74 has an outer diameter which is greater than the diameter of the opening 50 of the lift arm 32, 34. The lift arm 34 is held between plate 74 and the bearing 39. Accordingly, the lift arm 34 cannot be removed from the lift shaft 36 to the left before the securing plate 74 is removed. In the opposite direction, the lift arm 34 comes into contact with the bearing 39 of the lift shaft 36, so that the lift arm also cannot be moved to the right in the longitudinal axis of the lift shaft 36.

While the present invention has been described in conjunction with a specific embodiment, it is understood that many alternatives, modifications and variations will be apparent to those skilled in the art in light of the foregoing description.

Accordingly, this invention is intended to embrace all such alternatives, modifications and variations which fall within the spirit and scope of the appended claims.

We claim:

1. A connection between a lift arm and a lift shaft of hitch for connecting an implement to a vehicle, characterized by:
the lift arm having a opening which receives an end of the lift shaft, the opening and the end of the lift shaft having a polygonal cross sectional shape.

2. The connection of claim 1, wherein:
the opening and the end of the lift shaft having a cross-sectional shape which corresponds substantially to an equilateral triangle with rounded sides and/or corners, in particular in the form of an orbiform curve.

3. The connection of claim 1, wherein:
the cross-sectional shape is an equilateral polygon.

4. The connection of claim 3, wherein:
the opening and the end of the lift shaft have rounded corners.

5. The connection of claim 4, wherein:
the rounded corners have a circular or elliptical cross-sectional shape.

6. The connection of claim 1, wherein:
an entire periphery of the end of lift shaft engages the lift arm surrounding the opening.

7. The connection of claim 1, wherein:
the lift arm opening includes a surface which is substantially parallel to an outer surface of the lift arm.

8. The connection of claim 1, wherein:
the lift arm includes a slot which extends radially outwardly from the opening.

9. The connection of claim 8, further comprising:
a clamping member for clamping the lift arm to the lift shaft.

10. The connection of claim 9, wherein:
the clamping member comprises a screw and a nut, and the screw being inserted into a pair of aligned bores which are substantially perpendicular to the slot.

11. The connection of claim 8, wherein:
the slot lows the lift arm to be pushed onto the lift shaft with little force expenditure.

12. The connection of claim 1, further comprising:
a securing member for securing the lift arm to an end of the lift shaft.

13. The connection of claim 12, wherein:
an end bore extends into an end face of the lift shaft; and
the securing member comprises a screw and a plate, the plate having an outer diameter which is greater than a diameter of the lift arm opening, the screw being screwed into the end bore to hold the plate and the lift arm to the lift shaft.

14. The connection of claim 1, wherein:
the portions of the lift shaft and/or the lift arm are case hardened.
